(19) United States
(12) Patent Application Publication
(10) Pub. No.: US 2006/0218509 A1
(43) Pub. Date: Sep. 28, 2006

(54) Process and device for access to multimedia elements by means of images associated with these elements

(76) Inventors: Jurgen Stauder, Montreuil Sur Ille (FR); Izabela Grasland, Breteil (FR); Bertrand Chupeau, Rennes (FR); Carole Posson, Sevigniac (FR)

Correspondence Address: THOMSON LICENSING INC., PATENT OPERATIONS, PO BOX 5312, PRINCETON, NJ, 08543-5312, US

(21) Appl. No.: 10/540,457

(22) PCT Filed: Dec. 17, 2003
(86) PCT No.: PCT/EP03/51033

§ 371 Date: Feb. 6, 2006

(30) Foreign Application Priority Data
Jan. 2, 2003 (FR) 0300047

(51) Int. Cl. G06F 17/00

(52) U.S. Cl. 715/853; 715/968

(57) ABSTRACT

The invention relates to a process for access to multimedia elements stored by means of digital data, an image being associated with each element so as to control access to the latter. In accordance with the invention, such a process is characterized in that, when one wishes to access one of these elements, a first group of images associated with first elements is displayed, and means for displaying a second group of images associated with second elements, which group is distinct from the first group of images, is associated with at least one of these displayed images.

The present invention pertains to a process and to a device for access to multimedia elements by means of images associated with these elements.

It is known to use digital devices, that is to say those operating by means of digital data, to store or process multimedia elements comprising, for example, images, video sequences, pieces of music and/or texts.

Digital devices allow fast and easy processing of a multimedia element so as to perform an operation such as a copy, a modification or a transfer thereof. Thus, a photograph taken by means of a digital camera can be transferred to several computers, for example by means of an array of mobile memories, whereas, with the aid of one of these computers, it is possible to modify and to print the modified photograph via a printer.

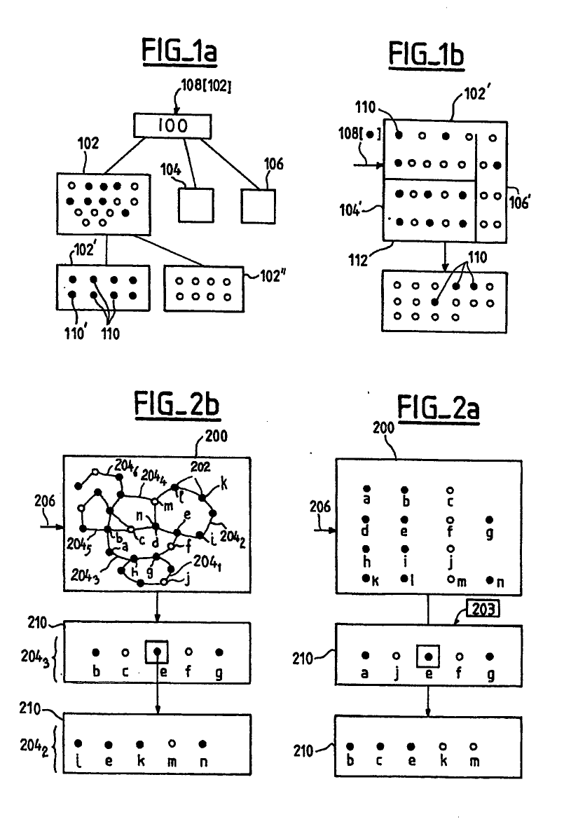

Access to a multimedia element 110 stored in a digital device generally calls upon a process of hierarchical organization or location (FIG. 1a) using folders 102, 104 and 106 and subfolders 102′ and 102″.

A hierarchical organization of folders can be defined automatically according to predetermined criteria such as the size or the date/period of storage of the multimedia elements. In this case, each subfolder comprises the multimedia elements relating to a given size and/or to a given date/period of storage.

A hierarchical organization may also be determined according to criteria defined by the user, such as a theme associated with the elements stored in a subfolder. In this case, when a user stores a multimedia element, he determines the folder or the subfolder comprising this element as a function, for example, of the theme with which the stored element is associated.

Thereupon, by sending a request 108 [102′] (FIG. 1a) identifying a subfolder by means, for example, of the theme 102′ associated with this subfolder, the user accesses all the elements 110 held in this subfolder 102′.

Such access may be performed by displaying images associated with these elements so that, by selecting an image, the user accesses the content of the element associated with this image.

Another known process (FIG. 1b) for access to multimedia elements can use selection criteria such that, when the user sends a request determining a selection criterion 108 [ ],the multimedia elements 110 meeting this criterion are selected, independently of their storage folder 102′, 104′ or 106′.

In this case, access to the selected multimedia elements may also be performed by means of images associated with them, as described above, so that by selecting an image, the user accesses the multimedia element associated with this image.

The present invention results from the finding that these known processes for access to a multimedia element stored in a digital device are unsuitable for numerous users and/or for numerous uses.

In fact, according to these processes for access based on location or based on selection criteria, the user wishing to access an element must have prior knowledge of information relating to the location of the element and/or to the selection criteria defining this element.

Now, such prior knowledge does not exist in numerous situations such as when these elements are stored in a device used by various people, one person storing the elements in the device while the other people are accessing these elements.

In fact, in this case, only the person storing the elements knows the information relating to the location and/or to the selection criteria used, thereby rendering access to an element difficult for the other people.

Furthermore, the location or the selection criteria allocated to a multimedia element may vary as a function of the person who performs this allocation, thereby rendering access to multimedia elements still more difficult when various people are using the device.

For example, an image representing members of a family, taken within the framework of a trip, could be located in a folder relating to family events by one person and in a folder relating to trips by another.

Moreover, these access processes have the drawback of providing, in response to a request, all the elements that may correspond to the request. Now, the number of these elements may be high to the point that the user does not feel in control of his access request and abandons his search.

Additionally, access based on selection criteria is generally restrictive, that is to say the successive defining of selection criteria successively limits the number of elements that a person can access by combining these various criteria.

Now, a user selecting elements may wish to modify his criteria during selection, for example by discarding criteria already used, in particular when this consultation is performed by way of recreation and/or with no predetermined search objective.

Finally, in a general manner, the known processes for access to elements stored in a multimedia device are not very user friendly for users who are not conversant with the operation of a digital device, and in particular its mode of storing data.

The present invention solves at least one of the abovementioned problems. It relates to a process for access to multimedia elements stored by means of digital data, an image being associated with each element so as to control access to the latter, characterized in that, when one wishes to access one of these elements, a first group of images associated with first elements is displayed, and means for controlling the display of a second group of images associated with second elements, which group is distinct from the first group of images, are associated with at least one of these displayed images.

Such a process allows fast and simple user access to multimedia elements without requiring prior knowledge of their location and/or of the nature of the selection criteria used to define these elements.

Additionally, the process allows simple consultation of all the elements stored since a user can access various groups of elements successively.

Moreover, it should be stressed that a process in accordance with the invention does not provide all the possible accesses to multimedia elements simultaneously since the images making it possible to access these elements are provided to the user by means of various successive groups of images.

Stated otherwise, the user can consider accessing first multimedia elements, accessible from a first group of images, or choose to request the presentation of a new group of images so as to consider accessing other elements.

This process therefore offers user-friendly, simple and fast access to multimedia elements without requiring knowledge relating to the storage of these elements.

In one embodiment, when a first group of images is displayed, means for displaying a third group of images associated with third elements, which group is distinct from the second group of images, are associated with at least one of the images of the second group of images.

Thus, the user of such a process can successively access groups of images so as, for example, to examine all the elements stored while having the feeling of “leafing through” them.

In one embodiment, a first group of images is displayed, automatically as soon as means for displaying images are activated.

Thus, a user having little knowledge relating to the processing of multimedia elements can easily access them since the displaying of images allowing access to them is performed by activating their means of display, such as a television screen or computer screen.

According to one embodiment, when an operation is performed on a multimedia element such as the display thereof, the storage thereof or the transmission thereof, means activating the display of a first group of images are displayed.

Thereupon, a user processing a multimedia element can access all of these elements through the images.

In one embodiment, when a group of images is displayed, means controlling operations, such as a modification, a storage or a transmission, are also displayed.

In one embodiment, a group of images is formed with a number of images that is less than the number of images associated with the multimedia elements stored.

According to one embodiment, the number of images displayed is less than ten, preferably less than six.

According to one embodiment, the elements corresponding to one and the same selection criterion forming a group, images associated with elements belonging to one and the same group are displayed in a group.

In one embodiment, one selects an image and/or a group from which are chosen images displayed by considering at least one of the following criteria: a frequency of access, a date of storage, a file size, technical parameters specific to the associated images such as a predominance of colour or the presence of determined reliefs in this image, a theme associated with the element, membership of one and the same semantic group, a similarity relating to the nature and/or to the content of the element, a random decision or a user's preferences.

In one embodiment, the multimedia elements relate to video sequences, images, pieces of music and/or texts.

According to one embodiment, a multimedia element relating to a photograph or to a video sequence, the image associated with this element is generated from this photograph or from this video sequence.

In one embodiment, an element is accessed by generating the display thereof.

According to one embodiment, the displaying of the images is performed according to a chronological mode or according to a thematic mode.

The invention also relates to a device for access to multimedia elements stored by means of digital data, an image being associated with each element so as to access the latter, characterized in that it comprises means for displaying a first group of images associated with first elements and controlling, on the basis of one of the images displayed, the displaying of a second group of images, associated with second elements, which group is distinct from the first group of images.

In one embodiment, the device comprises means for associating with at least one of the images of the second group means for displaying a third group of images, associated with third elements, which group is distinct from the second group of images.

According to one embodiment, the device comprises means for automatically displaying a first group of images as soon as means of display of images are activated.

According to one embodiment, the device comprises means for displaying means for activating the display of a first group of images upon an operation on a multimedia element such as the display thereof, the storage thereof or the transmission thereof.

According to one embodiment, the device comprises means for displaying images according to a chronological mode or according to a thematic mode.

Other characteristics and advantages of the invention will be become apparent with the description of the invention given hereinbelow, by way of nonlimiting example, while referring to the appended figures in which:

FIGS. 1a and 1b, already described, represent known processes for access to multimedia elements,

FIGS. 2a and 2b represent processes for access to multimedia elements in accordance with the invention,

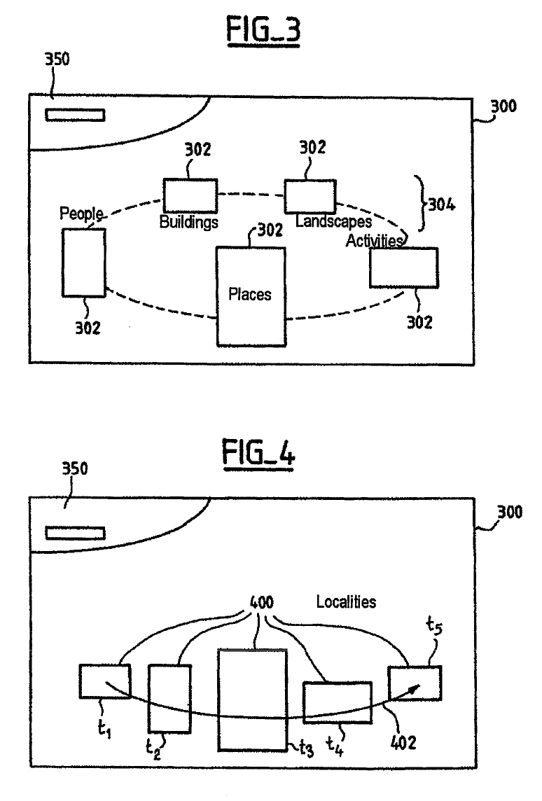

FIGS. 3 and 4 represent displays of images in accordance with the invention, and

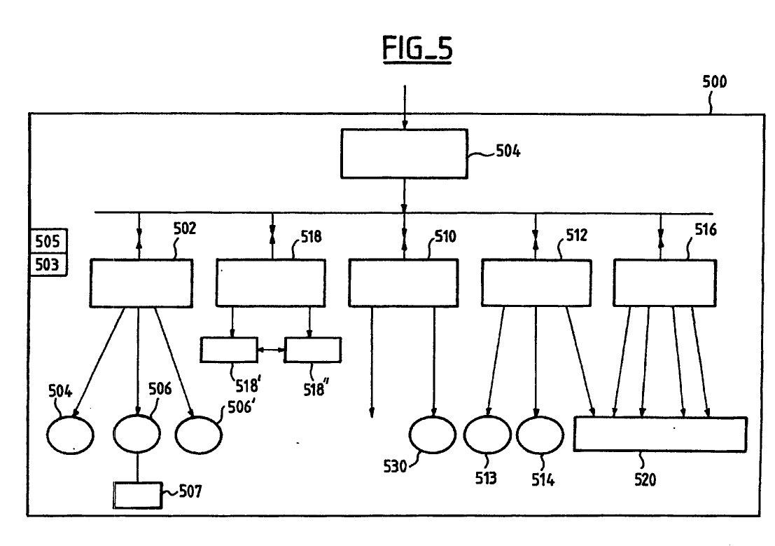

FIG. 5 is a chart of operations performed by a device in accordance with the invention.

Represented in FIG. 2a is a first process for-access to multimedia elements (not represented) in accordance with the invention, that is to say such that an image a, b, . . . j is associated with each element so as to control access to the latter.

In accordance with the invention, when access 206 to one of the multimedia elements stored in the digital device 200 is requested, a first group of images (a, j, e, f, g) associated with first elements stored in this device is displayed on a screen 210.

These images a, j, e, f and g comprise means of activation such that the multimedia element associated with an image is provided to the user if this image is activated. In this embodiment, this activation is performed with the aid of an activation request sent by the user by means of a remote control 203 allowing selection of an image.

Certain of these images, such as the image e, also comprise so-called navigation means such that a second group of images (b, c, e, k, m), distinct from the first group, is displayed as the user consults this image e, this navigation also being controlled from the remote control 203.

It is thus apparent that, by displaying groups of images successively, the user of the device 200 can get a fast and simple sense of the multimedia elements accessible, via the images displayed, in this device 200.

The selection of the images displayed in the first group of images and in the later groups of images is performed by means of criteria such as a date of storage of the multimedia element, a frequency of access to this element, a membership of one and the same semantic group, a similarity relating to the nature or to the content of these elements, a random decision or a preference of the user.

According to a variant of the invention represented in FIG. 2b, the images a, b, . . . n used by the device are associated with elements defined by means of selection criteria such as the location in a folder or a theme relating to the content of the element.

By considering the selection criteria, sets 204₁, 204₂, 204₃, 204₄ and 204₅ of elements satisfying one and the same (or several) criterion (criteria) are defined.

Certain of these elements may belong to various sets. Thus, the element associated with image b belongs to sets 204₃ and 204₅ while the element associated with image e belongs to sets 204₃ and 204₂.

Such a situation occurs when, for example, the set 204₃ corresponds to the elements relating to a trip, the set 204₂ corresponds to the elements relating to an exhibition and when the element associated with image e corresponds to a photograph taken during a trip made within the framework of an exhibition.

In this case, in accordance with a variant of the invention, a selection of a set 204₃ of elements is performed when it is detected that the user of the device 201 wishes to access a multimedia element. One then selects the group of images (b, c, e, f, g) displayed from among the images associated with elements contained in this set 204₃.

Such a selection of a set makes it possible to display images exhibiting a relationship such as dealing with one and the same theme or having a similar date of storage. Thus, the proposed groups of images exhibit a certain consistency for the user of the device 200.

The first set selected can be determined according to criteria such as the frequency of the accesses to the elements of a set, the chronology of these accesses, the membership of one and the same semantic group, a similarity relating to the nature and/or to the content of these elements, a random decision and/or preferences of the inventor.

As previously mentioned, certain of these images may belong to a second set of images. Thereupon, according to a variant of the invention, if a user consults an image e belonging to a second set 204₂, a new group of images i, e, k, m and n relating to elements contained in the second set 204₂ is displayed.

Represented in FIG. 3 is a screen 300 of a device for displaying digital photographs, in accordance with the invention. Thus, when the user activates this device so as to access photographs 302ᵢ stored in the latter, a group 304 of images associated with photographs is displayed.

The images 302_{activities}, 302_{landscapes}, 302_{buildings}, 302ₚₑₒₚₗₑ and 302_{places} displayed emanate from photographs with which they are associated, for example through a reduction in their size.

These images 302ᵢ have been selected to be displayed according to determined criteria. In this example, images relating to various themes such as landscapes or people are displayed.

Additionally, means of activation are associated with these images so that, when an image 302_{places} is activated, the associated photograph is displayed. In this case, the photograph is also image dependent, as shown in FIG. 300.

Means of consultation are also associated with each photograph so that, by consulting a photograph, a new group of images is displayed.

For example, considering image 302_{places} to be consulted, a new group 400 (FIG. 4) of images 400_{localities} is displayed along a time axis 402 corresponding to the date t on which this photograph was taken. Thus, a first image t₁ along this axis 402 has a date of storage prior to a second image t₂ which follows it.

Such a chronological presentation of the images displayed may be obtained, according to one embodiment of the invention, with a first group of images 304 displayed according to themes. Stated otherwise, the mode of display can vary with one and the same group of images.

In accordance with one embodiment of the invention, the display 300 comprises the presentation of means 350 of the digital device allowing, for example, the acquisition, the consultation, the creation, the modification or the sharing of multimedia elements, as described hereinbelow with FIG. 5 which represents various functionalities accessible to the user of a multimedia device 500 in accordance with the invention.

Prior to the description of these functionalities, it is appropriate to point out that they are proposed subsequently to an activation 504 of the navigation process in accordance with the invention. Thus, if the user activates the device 500 to access an element, a group of images selected as described with the aid of FIGS. 2a or 2b is displayed.

By means of his device 500, the user may wish to store (502) images by importing (504) the latter from an email, from a mobile recording medium such as a compact disc (CD), a DVD or a DVIX, or from a digital camera.

For this purpose, the device 500 comprises means 503 for receiving emails, for reading mobile recording media and/or for connecting digital devices such as a digital camera.

Additionally, the device 500 comprises means 505 for processing multimedia elements according to the various recording formats such as MPEG (Motion Picture Expert Group), JPEG (Joint Photographic Expert Group), BITMAP (pixel map) or TIFF (Tagg Image File Format).

The device also comprises a link with the Internet network, or a similar communication network, so as to allow the exchanging of elements received or transmitted via this network.

Likewise, the device comprises means for indexing (506) the elements processed by considering, for example, chronological criteria, selection themes or parameters allocated automatically to an element such as the size of an element.

To do this, the device comprises means 507 for allocating a date of production or of storage to an element, for determining a duration (start and end) of an element and/or for allocating one or more themes to an element, this operation being described later in detail with the aid of FIG. 6.

Additionally, the device 500 comprises means 508 for modifying an element, for example, by deleting it from a folder or by altering technical characteristics (framing, contrasts, light, colours).

The device 500 also comprises means 510 for searching for an element with the aid, for example, of a theme or of a date/duration.

The device can also comprises means for leafing through the images by selecting photographs exhibiting a relationship with a photograph currently being displayed (for example temporal or thematic ones) and in such a way as to display this selection of photographs when the user wishes to display new photographs.

The device also comprises means 512 for creating one or more sets 513 of elements, a set possibly corresponding to a theme such as childhood or a tourist trip. Thus, by considering the multimedia elements to be photographs, albums of photographs specific to various themes may be created.

In fact, the device comprises means 514 making it possible to consult an album by displaying the various elements stored in the latter. Such a display is performed in the form of a slide show, that is to say a successive displaying of the images associated with each element, for example according to a chronological and/or thematic order.

The device is also furnished with means 516 making it possible to share the multimedia elements processed by transmitting them by email, by downloading them to a mobile medium such as a “compact disc”, or by integrating them into a document accessible via the Internet network. Such sharing can also be performed with the aid of means 520 making it possible to produce “web” pages, that is say ones available from the Internet network, to attach an element to an email and to produce an album with elements.

Finally, the device comprises means 518 making it possible to display a group of images in accordance with the invention, and to do so according to a thematic organization (518′) or chronological organization (518″) as described earlier, as well as means 530 making it possible to search for a multimedia element according to one or more different criteria.

The present invention is open to numerous variants. Thus, the images considered may correspond to extracts of video sequences, obtained randomly or in a predetermined manner, so that the user accesses a video sequence by selecting an image according to the invention.

In this case, a video sequence currently being preselected is a movie while the others extracted are stills. According to another variant, the video sequence currently being preselected is associated with a sound while the others extracted are played in mute fashion.

In these various cases, the selection of films or of pieces of music can be made by genre, date, author or user profile.

In fact, a device in accordance with the invention can be associated with an apparatus such as a television or a digital decoder so as to offer various functionalities on the basis of a single multimedia system.

The process for access in accordance with the invention may be triggered automatically when it is detected that the user decides to access an element, for example to display it, to export it or to modify it.

1. Process for access to multimedia elements stored by means of digital data, an image being associated with each element so as to control access to the latter, wherein, when one wishes to access one of these elements,
a first group of images associated with first elements is displayed, and
means for displaying a second group of images associated with second elements, which group is distinct from the first group of images, are associated with at least one of these displayed images.

2. Process according to claim 1, wherein means for displaying a third group of images associated with third elements, which group is distinct from the second group of images, are associated with at least one of the images of the second group of images.

3. Process according to claim 1, wherein a first group of images is displayed automatically as soon as means for displaying images are activated.

4. Process according to claim 1, wherein when an operation is performed on a multimedia element such as the display thereof, the storage thereof or the transmission thereof, means activating the display of a first group of images are displayed.

5. Process according to claim 1, wherein when a group of images is displayed, means controlling operations, such as a modification, a storage or a transmission, are also displayed.

6. Process according to claim 1, wherein the number of images displayed is less than ten, preferably less than six.

7. Process according to claim 1, wherein the elements corresponding to one and the same selection criterion forming a group, images associated with elements belonging to one and the same group are displayed in a group.

8. Process according to claim 1, wherein one selects an image and/or a group from which are chosen images displayed by considering at least one of the following criteria: a frequency of access, a date of storage, a file size, technical parameters specific to the associated images such as a predominance of colour or the presence of determined reliefs in this image, a theme associated with the element, membership of one and the same semantic group, a similarity relating to the nature and/or to the content of the element, a random decision or a user's preferences.

9. Process according to claim 1, wherein the multimedia elements relate to video sequences, images, pieces of music and/or texts.

10. Process according to claim 1, wherein a multimedia element relating to a photograph or to a video sequence, the image associated with this element is generated from this photograph or from this video sequence.

11. Process according to claim 1, wherein an element is accessed by generating the display thereof.

12. Process according to claim 1, wherein the displaying of the images is performed according to a chronological mode or according to a thematic mode.

13. Device for access to multimedia elements stored by means of digital data, an image being associated with each element so as to access the latter, wherein it comprises means for,
displaying a first group of images associated with first elements, and
controlling, on the basis of one of the images displayed, the displaying of a second group of images, associated with second elements, which group is distinct from the first group of images.

14. Device according to claim 13, wherein it comprises means for associating with at least one of the images of the second group means for displaying a third group of images, associated with third elements, which group is distinct from the second group of images.

15. Device according to claim 13, wherein it comprises means for automatically displaying a first group of images as soon as means of display of images are activated.

16. Device according to claim 13, wherein it comprises means for displaying means activating the display of a first group of images upon an operation on a multimedia element such as the display thereof, the storage thereof or the transmission thereof.

17. Device according to claim 13, wherein it comprises means for displaying images according to a chronological mode or according to a thematic mode.
